(19) United States
(12) Patent Application Publication
(10) Pub. No.: US 2006/0141197 A1
(43) Pub. Date: Jun. 29, 2006

(54) Protective-decorative panel for household appliances applicable to diverse surfaces

(75) Inventors: Maria Belen Caparros Taracido, Madrid (ES); Luis Alberto Romero Angulo, Madrid (ES); Ana Caparros Alvarez, Madrid (ES)

Correspondence Address: WILLIAM COLLARD;COLLARD & ROE, P.C., 1077 NORTHERN BOULEVARD, ROSLYN, NY, 11576, US

(73) Assignee: PERSONAL & ORIGINAL, S.L.

(21) Appl. No.: 11/314,297

(22) Filed: Dec. 21, 2005

(30) Foreign Application Priority Data
Aug. 21, 2005 (ES) U200502304
Dec. 27, 2004 (ES) U200402912

(51) Int. Cl. B32B 33/00

(52) U.S. Cl. 428/40.1

(57) ABSTRACT

A protective-decorative panel for household appliances that can be applied to and removed from diverse surfaces; applicable to refrigerators, washing machines, dishwashers and the like, intended to cover part or all of the front, sides and/or cover of such household appliances, composed of a laminar body which coincides in shape and size with the surface of the household appliance to be protected and embellished, with the peculiarity that the said laminar body is magnetised for fastening to the appliance, its front or external side being equipped with a printed sheet that renders the ornamental nature to the set. Alternatively, the back of the body can be equipped with detachable and reusable fastening means by contact and on the obverse with decorative means made of diverse materials.

### OBJECT OF THE INVENTION

The present invention refers to an element, specifically a panel, conceived to protect and embellish household appliances such as refrigerators, washing machines, dishwashers and in general any type of household appliance with an iron or steel carcass, conveniently painted or clad. It also refers to a variation of the invention which applies not only to household appliances but to diverse surfaces as well.

The object of the invention is to achieve a protective-decorative element shaped in such a way as to be easily adaptable and fastened to the household appliance or surface in question, in a practically instantaneous manoeuvre and which can be moved or removed for greater durability, protection and decoration.

### BACKGROUND OF THE INVENTION

Household appliances such as refrigerators, washing machines and dishwashers are often part of the kitchen furniture and, as such, it would be desirable for such appliances to combine aesthetically with the furniture. However, most household appliance have smooth surfaces, generally with a white paint or lacquer finish that often breaks with the design of the kitchen furnishings.

In an attempt to solve this problem, some appliances come with panelable doors wherein they are equipped with a dismountable perimetrical section which enables them to be covered with a thin board such as, for example, with the same kind of wood as the rest of the furniture.

In addition to the complexity of the assembly, the aesthetic finish of this solution leaves a lot to be desired due to the need to implant the sections and the visibility of the screws that are used to fasten them.

In addition, when the front of the appliance is originally suited to the general design of the furniture in which it is integrated, the normal use of the appliance causes scraping and scratching of the directly accessible areas, which has a very negative impact on the aesthetics of the appliance and shortens its useful life.

The problem described above applied not only to the doors of the appliances but also to the side walls and/or upper base of same when these parts are directly visible and accessible.

In addition, there are certain appliances and other surfaces including non-ferromagnetic surfaces such as household and lift doors—made of metal or other materials—windows, glass dividers, furniture—made of metal or other materials—such as tables, benches or shelves, or directly to decorate walls, floors or ceilings; urban furniture such as billboards, canopies, light posts or vehicles such as cars, trains and buses where fastening by magnets would not be effective, wherefore it is necessary to improvise other removable methods for fastening the protector or panel. Moreover, the ornamental function limited to a simple pressed sheet enormously limits the expressive capabilities of the panel or protective device of the invention.

### DESCRIPTION OF THE INVENTION

The protective-decorative panel proposed by the invention has been conceived to resolve the previously described problem in a fully satisfactory manner.

To do so, more specifically, said protective-decorative panel takes the form of a basic sheet which coincides in shape and size with the surface to be protected or embellished, a laminar body preferably made of a magnetised PVC sheet, although it could also be made of any other material capable of being fastened to the surface of the appliance by simple approximation.

The laminar body is equipped on the front, with fixed or removable adhesive, a printed sheet with any type of image which can run the gamut from plain colours to photographs, illustrations, graphic designs, infography, etc. and which can be printed on a large format inkjet printer, by silk screening or traditional offset printing, acting in any case the said printed sheet as the protective and embellishing element of the household appliance in question.

The protective-decorative element thus structured, i.e., the panel composed of a magnetised laminar body and the printed sheet, can cover an entire surface, for example, the front of a household appliance, or only part of the surface by punching holes in the set to form windows that allow the original surface of the appliance to be seen, based on any design criterion.

In a variation of the invention shown in FIGS. 4 through 10, the laminar body can alternatively be equipped with fastening means by simple contact that are detachable and reusable, capable of fastening the element to any kind of surface, not just ferromagnetic surfaces. For example, such means could consist of loops, suction cups or the like affixed to the back of the laminar base.

Another improvement proposed by the invention consists of implementing on the reverse of the laminar base decorative means that are not limited to a simple printed sheet.

Furthermore, it will materialise on both the laminar base and on the means arranged on the front and back in materials with a certain flexibility or in portions of the right size to permit their adaptation to curved surfaces.

Some examples of such decorative means include: paper or plastic supports developed photographically or stamped which are then affixed to the obverse of the base.

Other examples of decorative means to be applied to the laminar base include: fabric, leather or fur, with or without stitching or embroidery; holograms and metals, laminated or otherwise, wood or cork, plastic, etc. In addition, these can be configured in a prominent relief which constitutes, in and of itself, a three-dimensional object “emerging” from the protective panel.

Finally, there is another alternative embodiment of the invention which consists of fastening the decoration directly on the obverse of the laminar body by applying a coat of paint using any technique.

### BRIEF DESCRIPTION OF THE DRAWINGS

To supplement the description of the invention and in order to provide a better understanding of the characteristics of the invention, according to an example of the preferred embodiment of the invention, the description is accompanied by a set of illustrative but non-limitative drawings representing the following:

FIG. 1.—Shows, according to a schematic representation of a frontal view of a household appliance equipped with the protective-decorative panel which is the object of this invention, specifically, a dishwasher.

FIG. 2.—Shows, according to a similar representation to that of FIG. 1, another appliance equipped with the protective-decorative panel of the invention, in this case a refrigerator with two doors.

FIG. 3.—Show, finally, a section of any one of the appliances that appear in the previous figures, at the level of the protective-decorative panel.

FIG. 4 shows a view of a lift door equipped with the protective-decorative panels of the invention.

FIG. 5 shows a column to which the protective-decorative panel of the invention has been affixed, adapting to the column thanks to its flexibility.

FIGS. 6, 7, 8, 9 and 10 show variations of the embodiment of the protective-decorative panel of the invention.

### DESCRIPTION OF A PRACTICAL EMBODIMENT OF THE INVENTION

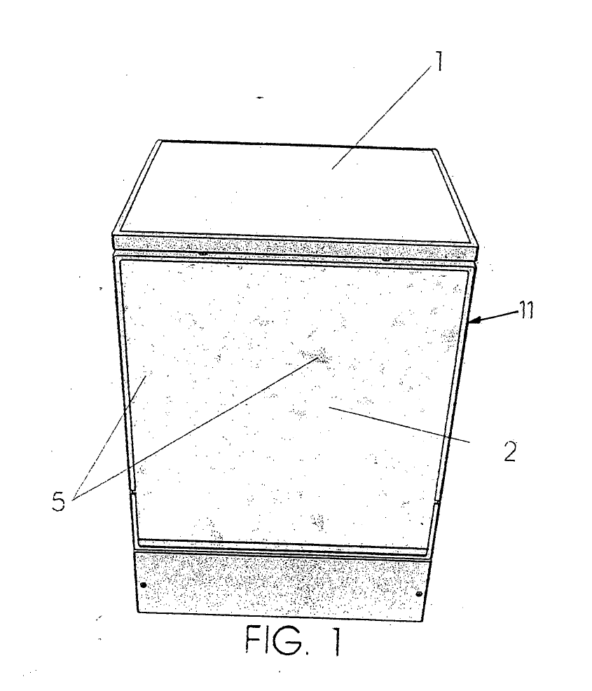

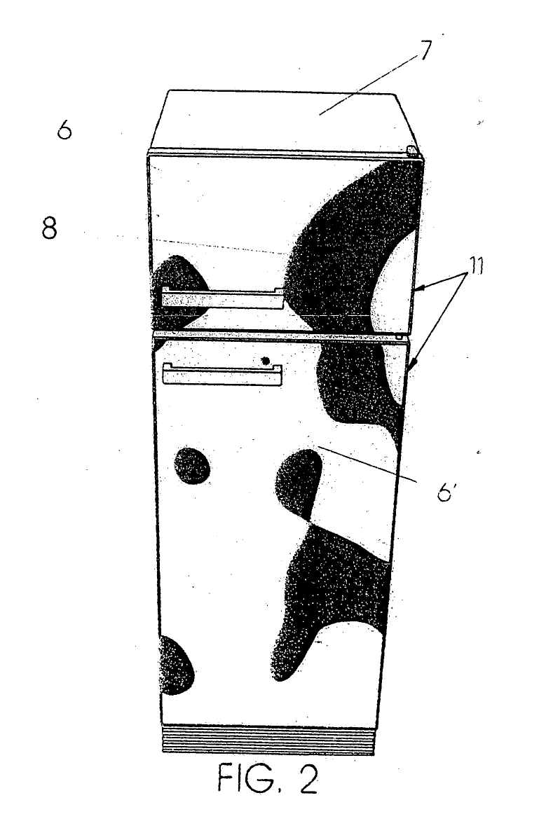

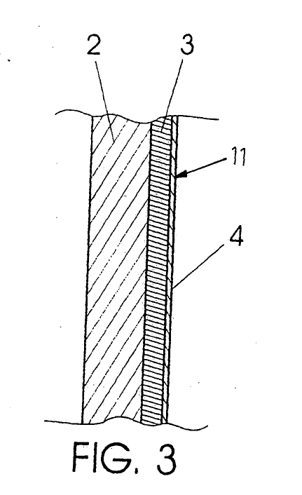

As mentioned above, FIG. 1 shows a dishwasher (1) the front portion of which (2) is completely covered by the protective-decorative panel (11) of the invention, in the form of a magnetised laminar base (3) such as, for example, a magnetise PVC sheet, which by its very nature is magnetically fastened to the sheet of the said front wall (2) of the dishwasher, which in turn is lined on the front side with a sheet (4) decorated with any kind of ornamental motif (5) which may have been printed on the sheet using an appropriate conventional method, fastening the said sheet (4) to the body (3) by adhesive, which in turn may be either permanent or removable, as also mentioned above.

A similar protective-decorative panel may be fastened to the upper base or to one or both sides of a kitchen appliance. This is the case of FIG. 2, in which the body (6) of the refrigerator appears with the upper base (7) completely covered by a protective-decorative panel, which complement those covering the two front doors (6-6′), and in which case the panel has a different design, derived from a discontinuation in the protective-decorative panel so that the set composed of the laminar body (3) and the printed sheet (4) are punched with holes (8) in an irregular configuration and arrangement which has a decisive impact on the overall aesthetic appearance.

As mentioned above, there is no limitation whatsoever on the design possibilities for the motifs (5) of the printed sheet (4), just as there is no limitation on the holes that can be punched in the protective-decorative panel if this option is chosen.

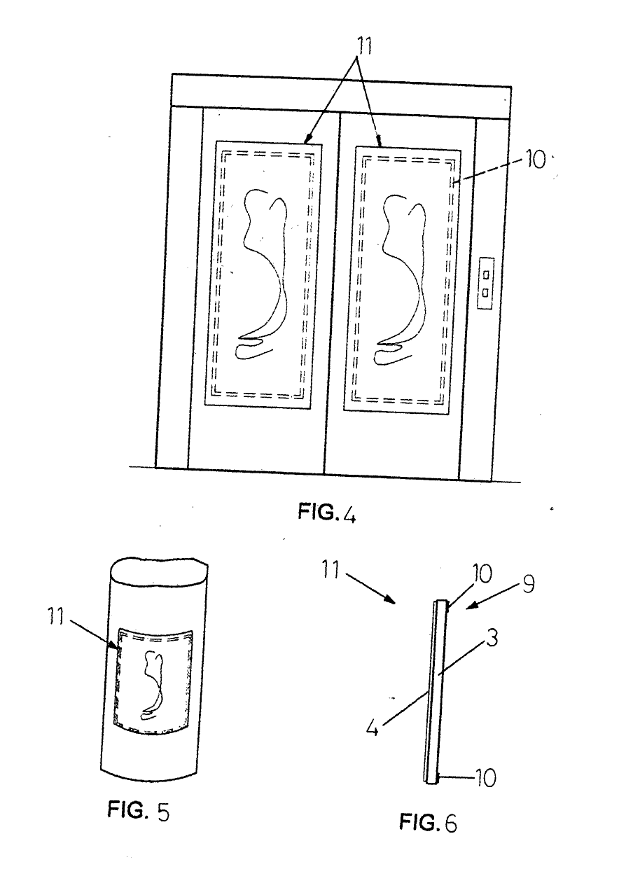

In the variation of the invention represented in FIGS. 4-10, the laminar body (3) is equipped on the reverse (9) with detachable and reusable fastening means by contact to any surface, not just ferromagnetic surfaces, these means consisting of portions (10) of adhesive loops in a non-limiting mode of the invention, although these means can also be composed of magnetised portions, suction cups or by direct magnetisation of the body (3). Obviously, if antagonistic means are required, as in the case of the adhesive loops, these are arranged on the panel.

In addition, the body (3) is preferably composed of any slightly flexible material in order to adapt to curved surfaces.

The decorative means are fastened to the obverse of the body (3) and may be composed of a sheet (4) of paper, plastic or other printed, stamped or photographically printed material with either a glossy or matte finish. The printing can be done using any technique including digital printing, silk screening, etc.

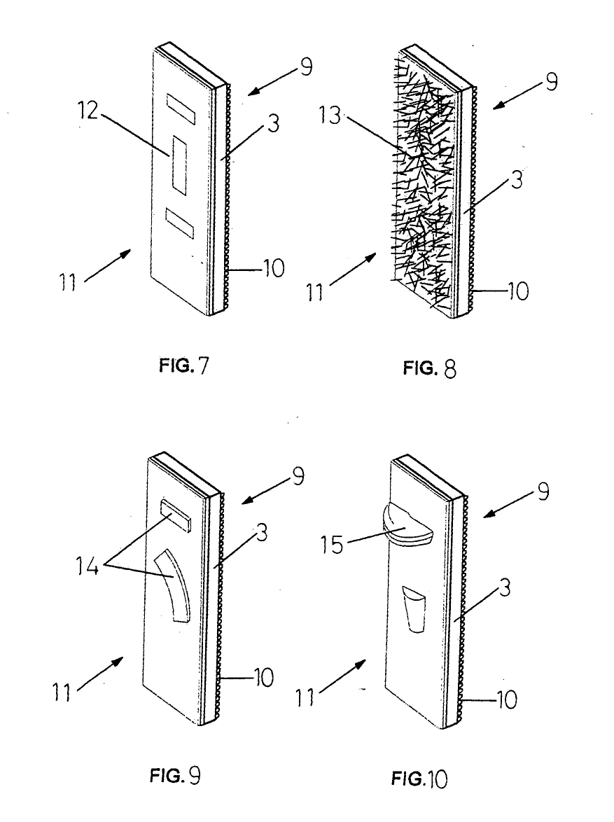

Likewise, as shown in FIGS. 7, 8, 9 and 10, respectively, it is also possible to fasten to the obverse of the body (3) all types of synthetic or natural fabrics or skins (12), furs (13), with or without stitching or embroidery, not represented, which can be used to trace drawings or graphics. These means may also consist of continuous or discontinuous pieces (14) of metal laminates, wood, etc. or other materials such as cork, resin, etc.

As shown in FIG. 10, it is also possible to affix figures in relief (15) made of any material and forming a single whole with the laminar body and protruding therefrom in three dimensions, as well as holograms and patterns, not represented.

Finally, invention also provides for the direct application on the obverse of the body (3) of a decoration based on a coat of paint, not represented, executed using any technique, whether oils or acrylics, water paints, pastels, pencils, etc.

The nature of the invention and the practical embodiment having been sufficiently described, it should be noted that the details of the arrangements indicated and represented in the attached drawings are subject to change, although the fundamental principle will not be altered.

1. A protective-decorative panel for household appliance which can be applied to and removed from diverse surfaces; applicable to refrigerators, washing machines, dishwashers, and similar used to cover part or all of the front, sides and/or cover of such appliances, wherein it is composed of a laminar body, coinciding in shape and size with the surface of the appliance to be protected and embellished, with the peculiarity that the said laminar body is magnetized for fastening to the appliance, its front or external side being equipped with a printed sheet that renders the ornamental nature to the set.

2. Protective-decorative panel according to claim 1, wherein the laminar body is composed of a magnetized PVC laminate.

3. Protective-decorative panel according to claim 1, wherein the printed sheet is affixed to the laminar body by permanent or removable adhesive.

4. Protective-decorative panel according to claim 1, wherein the external sheet is printed using any printing system and any motif, including anything from plain colours to photographs or illustrations, graphic designs or infography.

5. Protective-decorative panel according to claim 1, wherein the set composed of the laminar body and the printed sheet can be equipped with punch holes of any size and configuration, enabling part of the surface of the appliance to be visible.

6. Protective-decorative panel according to claim 1, wherein the laminar body can alternatively be equipped on the reverse with detachable and reusable fastening means by contact and on the obverse with decorative means made of diverse materials.

7. Protective-decorative panel according to claim 6, wherein the detachable and reusable fastening means by simple contact are composed of pieces of adhesive loop corresponding to matching portions arranged in the location where the panel is affixed.

8. Protective-decorative panel according to claim 6, wherein the laminar body and the means on the front and back are made of flexible materials and/or portions that enable the panel to be adapted and affixed to curved surfaces.

9. Protective-decorative panel according to claim 6, wherein the decorative means consist of a laminar paper or plastic support with photographic printing.

10. Protective-decorative panel according to claim 6, wherein the decorative means consist of a stamped laminar paper or plastic support.

11. Protective-decorative panel according to claim 6, wherein the decorative means consist of natural or synthetic fabric, leather or fur.

12. Protective-decorative panel according to claim 11, wherein the decorative means may alternatively include stitching or embroidery.

13. Protective-decorative panel according to claim 6, wherein the decorative means consist of metal sheets.

14. Protective-decorative panel according to claim 6, wherein the decorative means consist of wood or cork.

15. Protective-decorative panel according to claim 6, wherein the decorative means consist of plastic materials.

16. Protective-decorative panel according to claim 1, wherein the decorative means are three-dimensional.

17. Protective-decorative panel according to claim 6, wherein the decorative means are embodied in holograms.

18. Protective-decorative panel according to claim 6, wherein the decorative means are embodied in a coat of paint applied using any method.
